(19) United States
(12) Patent Application Publication
(10) Pub. No.: US 2012/0123842 A1
(43) Pub. Date: May 17, 2012

(54) METHOD AND APPARATUS FOR DELIVERING AN IDENTIFICATION REPRESENTING A MEDICATION ADHERENCE INCENTIVE

(75) Inventors: Pulin Patel, Andover, MA (US); Bihari Srinivasan, Andover, MA (US)

(73) Assignee: RXCONVERGE, LLC, North Andover, MA (US)

(21) Appl. No.: 13/280,942

(22) Filed: Oct. 25, 2011

Related U.S. Application Data
(60) Provisional application No. 61/412,481, filed on Nov. 11, 2010.

(51) Int. Cl. G06Q 30/02; G06Q 50/22

(52) U.S. Cl. 705/14.25; 705/2

(57) ABSTRACT

Generating an identification representing a medication adherence linked incentive and initiating a transmission of the identification to an identification display device by receiving a request from user at the server, generating the identification, associating the identification with the user, associating the combined user and identification with a medication adherence inventive protocol, and initiating a transmission of the identification to an identification display device.

### RELATED APPLICATION

The present application claims the benefit of and priority to U.S. provisional patent application Ser. No. 61/412,481, filed Nov. 11, 2010, the content of which is incorporated by reference herein in its entirety.

### TECHNICAL FIELD

The present disclosure generally relates to delivering a medication adherence incentive using an identification.

### BACKGROUND INFORMATION

Adherence to prescription medication has a clear benefit to patients' health. Modern medication adherence protocols can be complicated by number of times medication is taken, with or without food, interactions with other medications and over-the-counter remedies. Certain types of medication reminder systems are commonly available such as a weekly pill planner, AM/PM pill case. Recently, modern technology has been utilized to assist patients in adhering to their therapeutics including, specialty medication packaging at the pharmacy, automated phone call reminders, and text messaging. Despite the availability of adherence assistance tools, adherence to medications remains low and continues to have a negative impact on patients' health and increase downstream healthcare costs. Therefore, a system that can increase adherence to medication protocol is needed.

### SUMMARY OF THE INVENTION

The embodiments described in this document relate to server and a method for generating a user identification representing medication adherence linked incentives, associating with medication adherence incentive protocol, and initiating transmission to an identification display device. The method may be implemented, at least in part, by receiving a request from a user for an identification representing an adherence linked incentive at the server, generating or retrieving a new identification, associating the identification with the user, and initiating a transmission of the identification to an identification display device. The method may be further implemented by user receiving and displaying the barcode display device, transcribing the identification, inputting the transcribed identification in a processing device, and applying the requested adherence linked incentive associated with the identification to a purchase.

One embodiment of the invention includes sending an automated authorization request to user for medication refill request to pharmacy with user authorization code and/or automated authorization request to user for medication refill authorization request to physician with user authorization code to maintain adherence to medication adherence incentive protocol. The user may also receive automated reminder messages to take medications with user acknowledgment code. Additionally, the user may also receive user specific adherence messaging.

Another embodiment of the invention includes sending an advertisement along with the identification to the user. In that embodiment, associating the adherence incentive with the identification further comprises: combining the identification with an advertisement. The identification and/or advertisements may be sent using SMS or MMS messaging. An addition embodiment of the invention includes the identification represented by a barcode that is scanned by a scanner and applied to a purchase.

An alternative embodiment may include initiating transmission of user authorization request for medication refill request to pharmacy with user authorization reply code and/or refill authorization request to physician with user authorization code and identification representing an adherence linked incentive to identification display device. The embodiment may be implemented, at least in part, retrieving previously associated identification with user identification representing adherence linked incentive and previously associated mediation adherence incentive protocol; initiating transmission of authorization request to user, receiving user authorization code, initiating a user authorized refill request and/or user authorized refill authorization request transmission to pharmacy and/or physician, receiving pharmacy processing data, initiating a transmission of identification to identification display device. The method may be further implemented by receiving and displaying the identification on the identification display device, transcribing the identification, inputting the identification in a processing device, and applying the requested adherence incentive associated with the identification to a purchase.

In another embodiment, the user may also receive automated reminder messages to take medications with user acknowledgment code and the user may also receive user specific adherence messaging. Another additional embodiment of the invention includes sending an advertisement along with the identification to the user. In that embodiment, associating the adherence incentive with the identification further comprises combining the identification with an advertisement. The identification and/or advertisements may be sent using SMS or MMS messaging. An addition embodiment of the invention includes the identification represented by a barcode that is scanned by a scanner and applied to a purchase.

One embodiment includes a server for generating identification, associating it with a medication adherence incentive protocol, and initialing a transmission of the identification to an identification display device. The server includes a processor, a memory, and a transceiver. The transceiver may be configured to receive a request for identification representing and adherence linked incentive. The transceiver may also initiate a transmission of an identification associated with the adherence linked incentive to an identification display device. The memory may be configured to store identifications and medication adherence incentive protocols. The processor may be configured to receive the request for identification and associate the medication adherence incentive protocol with the identification. The memory may be configured to store at least one advertisement. The processor may be further configured to combine the identification representing an adherence linked incentive that is associated with the medication adherence incentive protocol with the advertisements. The transceiver is further configured to initiate a transmission of the identification associated with medication adherence incentive protocol and advertisement to the identification display device.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same or similar parts throughout the different views. Also, the drawings are not necessarily to scale, emphasis instead generally being placed upon illustrating the principles of the invention.

FIG. 1 is a block diagram illustrating a system for generating and processing an identification representing an adherence linked incentive.

FIG. 2 is a block diagram of a system for supporting a device generating an identification and associating it with an adherence linked incentive.

FIG. 3 is a block diagram of a server for generating identification representing an adherence linked incentive.

FIG. 4 is a block diagram of an apparatus for transcribing an identification representing an adherence linked incentive and applying the incentive to a purchase.

FIG. 5 is a flowchart of a method for generating an identification and associating it with an adherence linked incentive that was requested through SMS messaging or some other similar messaging service.

FIG. 6 is a flowchart of initiating transmission of user authorization request for medication refill request to pharmacy and/or refill authorization request to physician and identification representing a medication adherence linked incentive to identification display device.

### DESCRIPTION

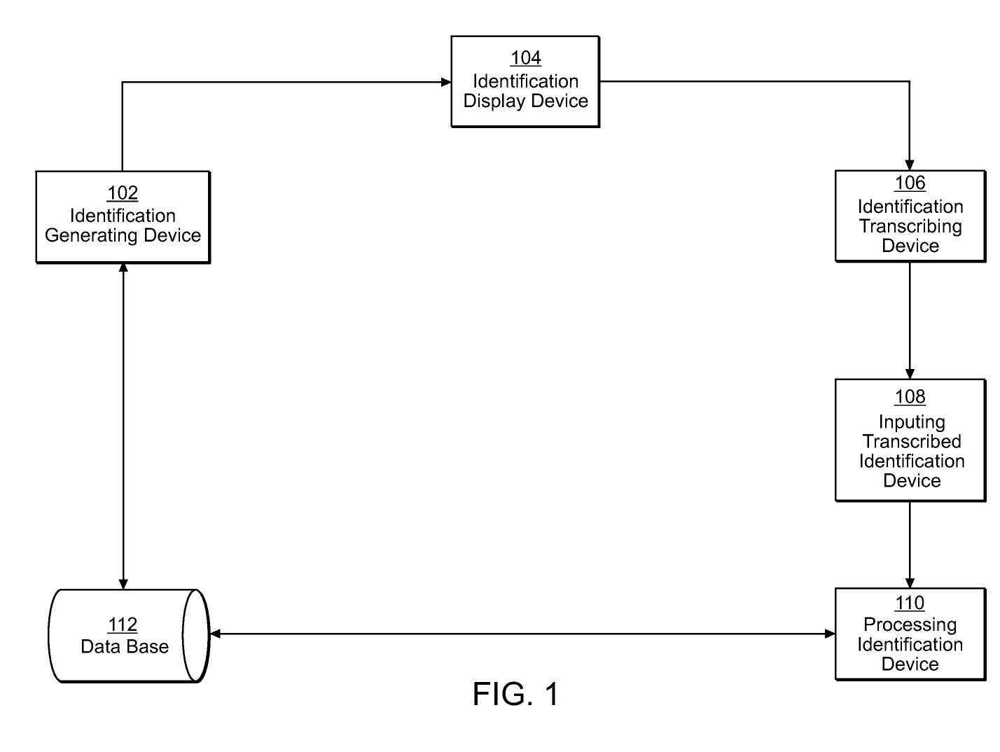

FIG. 1 represents a system for generating and processing an identification representing an adherence linked incentive. The system includes an identification generating device 102, an identification display device 104, an identification transcribing device 106, an inputting transcribed identification device 108, processing identification device 110, and a database 112. In one embodiment, the identification generating device 102 may generate an identification associated with a personal identifier such as a phone number or some other personal identifier. The identification generating device 102 may further associate the identification with an adherence linked incentive. The identification generating device 102 may use the database 112 to associate the identification with the user identifier and the adherence linked incentive.

The identification generating device 102 may initiate a transmission of the identification to the identification display device 104. The identification display device 104 may display the identification for transcribing by an identification transcribing device 106. The identification transcribing device 106 may transcribe the identification for the inputting transcribed identification device 108. The inputting transcribed identification device 106 may input the identification in the processing identification device 110. The processing identification device 110 may use the database 112 or local database with similar properties to determine the adherence linked incentive associated with the identification. The adherence linked incentive may be applied to the purchase by the processing identification device 110 or another device downstream.

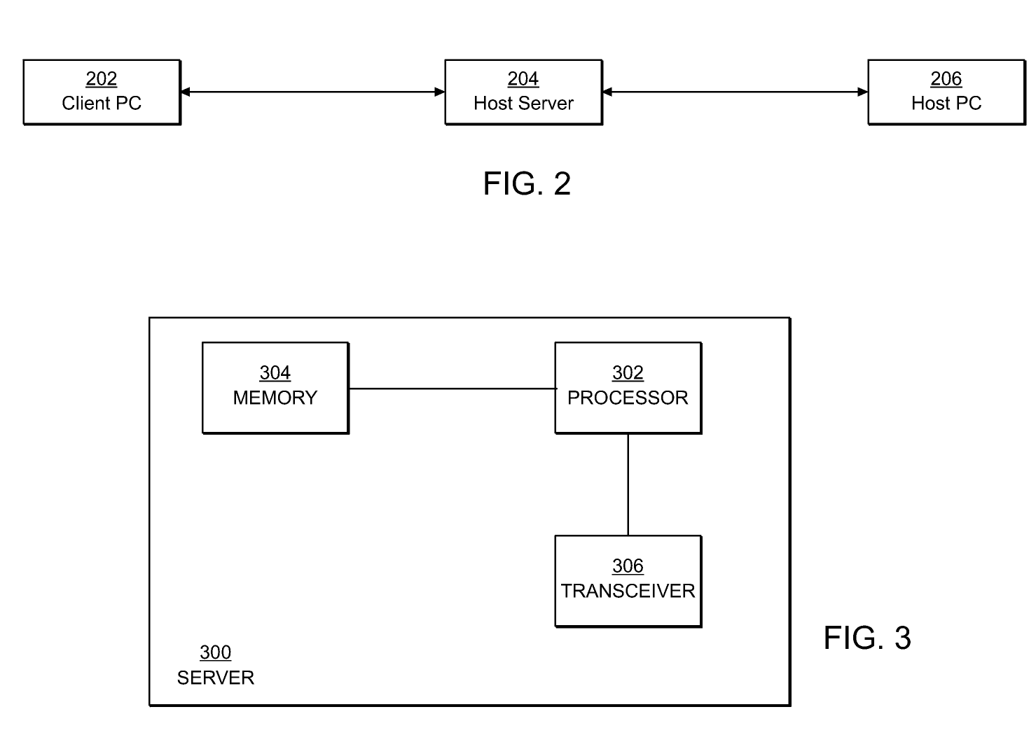

FIG. 2 is a block diagram of a system for supporting a device generating an identification and associating it with an adherence linked incentive. In one embodiment, the system may comprise a client PC 202, a host server 204, and host PC 206. The host PC 206 may be used by the hosting company to build, test, and update programs that will be used on the host server 204. The client PC may be used by the client company running the adherence linked incentive promotion to create and manage adherence linked incentives and promotion campaigns that will be run from the host server 204. The host server may be used to run the ‘live’ program. The ‘live’ program may be built, tested, and updated by the hosting company using the host PC 206. Adherence linked incentives and promotion campaign parameters may be set by the client company using client PC 202. The adherence linked incentive and promotion campaign may include: start and end date, amount or percentage of incentive, promotional messages, and/or medication adherence incentive protocol.

FIG. 3. is a block diagram of a server for generating identification representing an adherence linked incentive. In one embodiment, the server 300 may comprise a processor 302, a memory 304, and a transceiver 306. The transceiver 306 may also be configured to initiate transmission of an email, SMS, MMS or other type of message comprising an identification, generated by the processor 302. The transceiver 306 may be configured to send transmissions through typical wired and wireless communication channels. For example, these methods include Ethernet protocols, phone lines, USB, Firewire, cellular networks, IEEE 802.11 based standards (WiFi), IEEE 802.15 based standards (Bluetooth), and other types of communication channels. The transceiver 306 may be any logic, or combination of logic that allows the server to send and receive data. The server 300 may further comprise a memory 304. The memory 304 may store identification data, identification images and adherence linked incentive data. The memory 304 may be used to store the user-identification-adherence linked associations, performed by the processor 302. The server 300 may further comprise a processor 302. The processor 302 may be configured to receive requests for adherence linked incentives from the transceiver 306. The requests may include user data and adherence linked data detailing the user requesting the adherence linked incentives requested by user. The processor 302 may use the user data to determine whether a user is a new user. If the user is not a new user the processor 302 may retrieve a previously generated identification associated with the user from the memory 304. If the user is a new user, the processor 302 may be used to generate a new barcode to be associated with the user and stored in memory 304. The processor 302 may be further configured to associate the retrieved or generated identification with adherence linked incentive in the medication adherence incentive protocol data and send the identification to the transceiver 306.

In alternative embodiment, the server 300 may be configured to send an advertisement along with the barcode to barcode display device. In this alternative embodiment, the memory 304 will be further configured to store advertisements. The memory 304 may also store a user profile that tracks the user's coupon requests. The processor 302 may be further configured to combine the retrieved or generated identification with an advertisement stored in memory 304. The processor 302 may be further configured to use the user profile stored in memory 304 to pick an advertisement to use. The transceiver 306 may be further configured to receive the advertisement-identification combination from the processor 302 and initiate a transmission of the advertisement-identification combination to the identification display device.

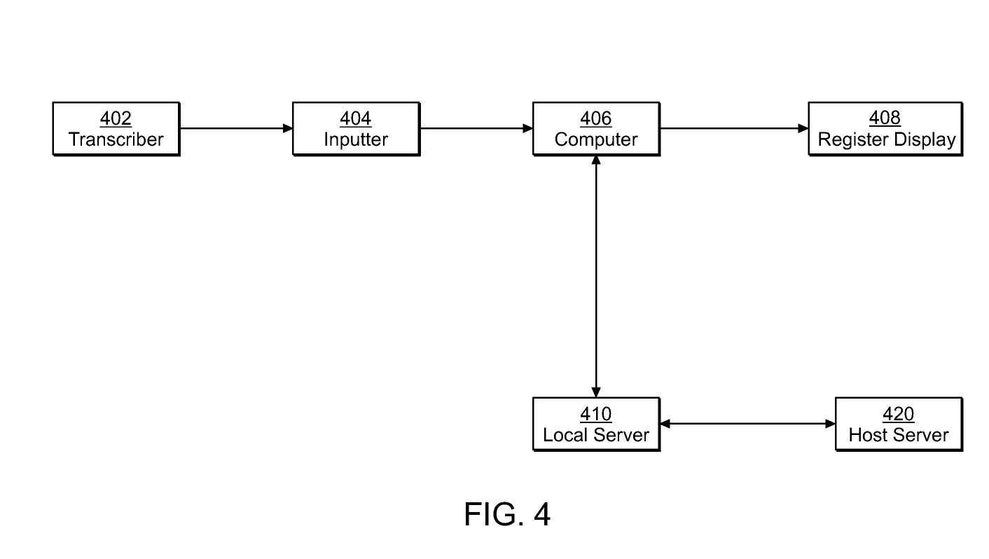

FIG. 4 is a block diagram of an apparatus for transcribing an identification representing an adherence linked incentive and applying the incentive to a purchase. In one embodiment, the identification reading device includes a transcriber 402 and an inputter 404. The inputter 404 inputs the identification to a computer 406. The computer 406 is coupled to a register display 408 and a local server 410. The local server 410 communicates with a host server 412 using various communication methods, including a direct connection, telephone line, and internet connection. In operation, the identification transcribing device may transcribe the identification using a transcriber 402, input the transcribed identification using an inputter 406, and process the identification using at least one of the computer 406, the local server 410, and the host server 412. Once the identification has been processed, the computer 406 may display the discount on the register display 408. In an alternative embodiment, the local server 410 and host server 412 may be the same server. This server would be coupled to the computer 404 through some communication line which may be wired or wireless. Examples of such communication lines include: WiFi, Phone Line, Internet, Ethernet and other communication protocols.

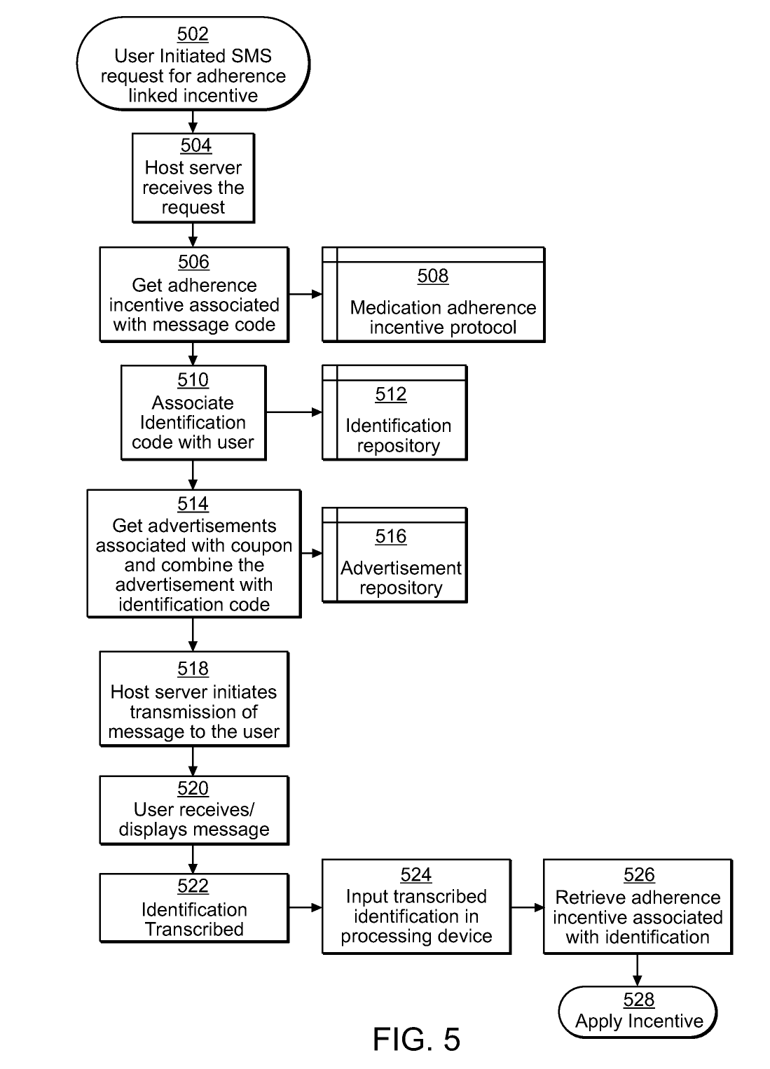

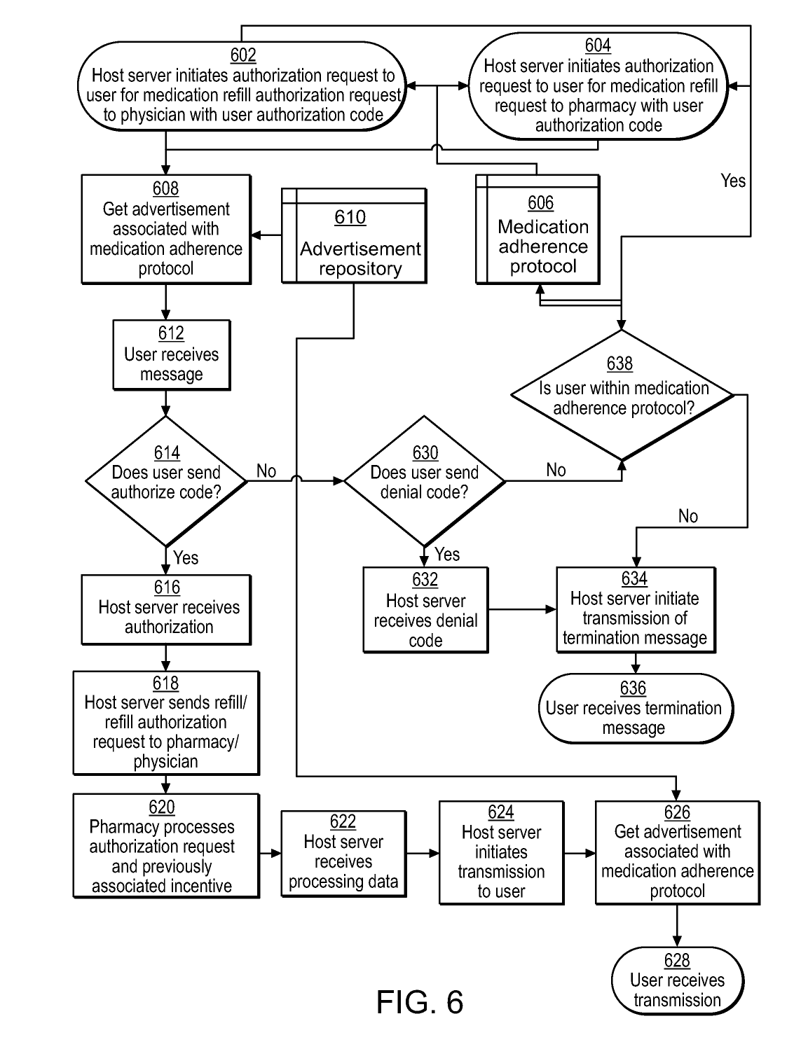

FIG. 5 is a flowchart of a method for generating an identification and associating it with an adherence linked incentive that was requested through SMS messaging or some other similar messaging service. In one embodiment, the user may request the adherence linked incentive through the use of SMS messaging using a portable device. The user may initiate a request for the adherence linked incentive by sending an SMS message 502. The user may initiate the exchange in response to viewing an advertisement listing a message code and a specific short code. These advertisements may include, but are not limited to, in-store displays, printed publication, and multimedia advertisements on television or the internet. The host server may receive the request from the user 504. The host server may access a medication adherence protocol 508 to retrieve the adherence linked incentive requested by the user SMS message 506. The host server may generate or retrieve a new identification from the identification repository 512 and associate it with the user 510. For example, the host server may use a personal identifier, such as a phone number or other unique ID, to identify the user and may associate the identification with the user's unique ID. The host server may associate the identification with the adherence linked incentive from the medication adherence incentive protocol 508. The host server may retrieve advertisements from an advertisement repository 516 and combine the barcode and the advertisement into an SMS message 514. The host server may select advertisements using location of the user, time adherence linked incentive was requested or current time, gender or user, age of user, previous adherence linked incentives, and medication adherence. The host server may select advertisement based on any data available in the medication adherence incentive protocol or user profile. The host server may initiate a transmission of an SMS message to the user include the identification and advertisement 518. The user may receive the SMS and display the identification and advertisement on their portable device 520. The identification may then be transcribed using a transcribing device 522. The inputting device may input the identification in the processing device 524. The processing device may retrieve the adherence linked incentive 526 using a local database that is synced with the host server to include information necessary to process the identification 528. Alternatively, the processing device may be coupled to the host server through a wired or wireless connection and may use the information on the host server to process the identification.

FIG. 6 is a flowchart of initiating transmission of user authorization request for medication refill request to pharmacy and/or refill authorization request to physician and identification representing a medication adherence linked incentive to identification display device. In one embodiment, the host server may initiate an SMS message to user for medication refill authorization request to physician 602 with user authorization and denial code when refills are required to continue adherence to medication 606. In another embodiment, the host server may initiate an SMS message to user for medication refill request to pharmacy 604 with user authorization and denial code when a refill is due based on medication adherence protocol 606. The host server may initiated transmission of SMS message that may combine an advisement 608 retrieved from the advertisement repository 610. The host server may select advertisements using location of the user, time adherence linked incentive was requested or current time, gender or user, age of user, previous adherence linked incentives, and medication adherence. The user may receive and view the host server initiated SMS with advertisement 612. The user may authorize refill request to pharmacy or refill authorization request to physician with an SMS acknowledgment code 614. The host server may receive 616 the user sent authorization code and initiates transmission of refill authorization to the pharmacy or physician 618. In operation, the host server initiated transmission to pharmacy or physician may in the form of fax, email, e-scribe, telephonic interactive voice response system. The pharmacy may process the authorization request with previously associated medication incentive or receive refill authorization from the physician to refill medication 620. The processing data may be received by host server 622 and host server may initiate transmission of processed refill to user with user identification 624. The host server may initiate SMS message combined of an advisement 626 retrieved from the advertisement repository 610. The user receives the notification of processed refill with identification and advertisements 628.

The user may reply with a denial code 630. The denial code may be received by the host server 632. The host server may initiate a transmission of an SMS message of termination of adherence linked incentive to the user 634. The user may then view the termination message 636. Alternatively, the user may not respond with either an authorization nor denial code 630. If the user is within medication adherence incentive protocol 638 then the host server initiates an authorization request to user for medication refill authorization request to physician or refill request authorization to pharmacy 602,604. If the user is not within medication adherence incentive protocol 606 then the host server initiates transmission of termination message 634 that maybe viewed by the user 636.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

What is claimed is:

1. A method for generating an identification representing medication adherence linked incentives, associating with medication adherence incentive protocol, and initiating transmission to an identification display device comprising:
receiving request from a user for medication adherence linked incentive;
generating identification;
associating user with identification;
associating said identification representing medication adherence linked incentive with medication adherence incentive protocol; and
initiating a transmission of said identification representing medication adherence linked incentive to identification display device.

2. The method of claim 1 further comprising the step of:
receiving and displaying said identification representing medication adherence linked incentive on said display device;
transcribing said identification representing medication adherence linked incentive from identification display device;
inputting said transcribed identification representing medication adherence linked incentive in processing device; and
applying said requested adherence incentive associated with identification to purchase.

3. The method of claim 1 wherein said medication adherence protocol system further comprises an automated authorization request to user for medication refill request to pharmacy with user authorization code and/or automated authorization request to user for medication refill authorization request to physician with user authorization code.

4. The method of claim 1 wherein said medication adherence protocol system further compromises an automated reminder to take medication message with user acknowledgement code.

5. The method of claim 1 wherein said medication adherence protocol system further comprises an automated user specific adherence messaging.

6. The method of claim 1 wherein said step of associating said identification representing an adherence linked incentive and medication adherence incentive protocol further comprises combining said identification with an advertisement.

7. The method of claim 1 wherein said transmission is an SMS message.

8. The method of claim 1 wherein said transmission is an MMS message.

9. The method of claim 1 wherein said transmission is an electronic mail.

10. The method of claim 1 wherein said identification is a barcode and further comprising the steps of:
receiving and displaying said barcode on said identification display device;
scanning said barcode and retrieving the data on said barcode using a barcode reading device; and
applying said requested adherence linked incentive associated with said barcode to a purchase.

11. A method initiating transmission of said user authorization request for medication refill request to pharmacy and/or refill authorization request to physician and said identification representing a medication adherence linked incentive to said identification display device comprising:
retrieving previously associated identification with user identification representing adherence linked incentive and previously associated said medication adherence incentive protocol;
initiating transmission of authorization request to user;
receiving user authorization code;
initiating a transmission to pharmacy and/or physician;
receiving pharmacy processing data; and
initiating a transmission of said identification to said identification display device.

12. The method of claim 11 further comprising the step of:
receiving and displaying said identification representing medication adherence linked incentive on said display device;
transcribing said identification representing adherence linked incentive from identification display device;
inputting said transcribed identification representing adherence linked incentive in processing device; and
applying said requested adherence linked incentive associated with identification to purchase.

13. The method of claim 11 wherein said medication adherence incentive protocol further compromises an automated reminder message to take medication with user acknowledgement code.

14. The method of claim 11 wherein said medication adherence incentive protocol further comprises an automated user specific adherence messaging.

15. The method of claim 11 wherein said step of associating said identification representing a adherence linked incentive and medication adherence incentive protocol system further comprises combining said identification with an advertisement.

16. The method of claim 11 wherein said transmission is an SMS message.

17. The method of claim 11 wherein said transmission is an MMS message.

18. The method of claim 11 wherein said transmission is an electronic mail.

19. The method of claim 11 wherein said identification is a barcode and further comprising the steps of:
receiving and displaying said barcode on said identification display device;
scanning said barcode and retrieving the data on said barcode using a barcode reading device; and
applying said requested adherence linked incentive associated with said barcode to a purchase.
